(19) United States
(12) Patent Application Publication
(10) Pub. No.: US 2023/0224099 A1
(43) Pub. Date: Jul. 13, 2023

(54) SEMI-PERSISTENT SCHEDULING (SPS) AND CONFIGURED GRANT (CG) TRANSMISSION PARAMETER ADJUSTMENT

(71) Applicants: Siyi CHEN, San Diego, CA (US); Changlong XU, San Diego, CA (US); Jing SUN, San Diego, CA (US); Xiaoxia ZHANG, San Diego, CA (US); Rajat PRAKASH, San Diego, CA (US); QUALCOMM Incorporated, San Diego, CA (US)

(72) Inventors: Siyi CHEN, Beijing (CN); Changlong XU, Beijing (CN); Jing SUN, San Diego, CA (US); Xiaoxia ZHANG, San Diego, CA (US); Rajat PRAKASH, San Diego, CA (US)

(21) Appl. No.: 17/925,278

(22) PCT Filed: Jul. 30, 2020
(86) PCT No.: PCT/CN2020/105811

§ 371 Date: Nov. 14, 2022

(51) Int. Cl. H04L 1/1867; H04W 72/11; H04W 72/232

(52) U.S. Cl. CPC H04L 1/1887; H04L 1/189; H04W 72/11; H04W 72/232

(57) ABSTRACT

A method of wireless communication performed by a user equipment (UE) incudes receiving supplemental semi-persistent scheduling (SPS) via radio resource control (RRC) signaling. The method also includes receiving the downlink re-transmissions according to the supplemental SPS. A method performed by the UE also includes receiving downlink feedback information (DFI) for a packet and determining one or more of resource block allocation, a start and length indicator value (SLIV), or a number of repetitions for re-transmission of the packet in response to the DFI. The method further includes re-transmitting the packet during a re-transmission period based on one or more of the resource block allocation, the SLIV, or the number repetition.

### FIELD OF THE DISCLOSURE

Aspects of the present disclosure generally relate to wireless communications, and more particularly to techniques and apparatuses for adjusting 5G new radio (NR) semi-persistent scheduling (SPS) and configured grant (CG) transmission parameters.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP).

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### BRIEF DESCRIPTION OF THE DRAWINGS

So that features of the present disclosure can be understood in detail, a particular description, may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example of downlink semi-persistent scheduling (SPS) transmissions.

FIG. 4A is a block diagram illustrating an example of Type 1 configured grant uplink transmissions.

FIG. 4B is a block diagram illustrating an example of Type 2 configured grant uplink transmissions.

FIG. 5A is a block diagram illustrating an example of a resource block (RB) allocation, in accordance with aspects of the present disclosure.

FIG. 5B is a block diagram illustrating an example of switching parameters during re-transmissions, in accordance with aspects of the present disclosure.

FIG. 6 is a block diagram illustrating an example of a Type 2 configured grant transmission and re-transmissions, in accordance with aspects of the present disclosure.

FIG. 7 is a diagram illustrating an example process performed, for example, by a user equipment (UE), in accordance with various aspects of the present disclosure.

FIG. 8 is a diagram illustrating an example process performed, for example, by a UE, in accordance with various aspects of the present disclosure.

FIG. 9 is a diagram illustrating an example process performed, for example, by a base station, in accordance with various aspects of the present disclosure.

FIG. 10 is a diagram illustrating an example process performed, for example, by a base station, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

5G new radio (NR) Release 17 and beyond provides quality of service (QoS) parameters for improving a radio access network (RAN). The parameters may include, for example, survival time and burst speed. Survival time may improve various services, such as enhanced industrial internet of things (IIoT) and ultra-reliable low latency communications (URLLC). The latency and/or reliability specifications for these services (e.g., IIOT and URLLC) may differ from other 5G NR services, such as enhanced mobile broadband (eMBB). As an example, applications implementing the URLLC service (e.g., URLLC applications) may transmit and/or receive critical traffic. In most cases, URLLC applications may be associated with low latency and high reliability specifications.

In some cases, 5G NR systems may support semi-persistent scheduling (SPS) and/or configured grant (CG) transmissions to reduce latency and/or reduce overhead. The reduced latency and/or overhead may satisfy survival time specifications for services, such as URLLC and IIOT. The SPS and/or configured grant transmissions supported in conventional systems may not satisfy survival time specifications.

For example, conventional systems may support SPS and/or configured grant transmissions on an initial (e.g., first) transmission. Still, these systems may fail to support SPS and/or configured grant transmissions on subsequent (e.g., second, third, etc.) re-transmission(s). In these cases, the re-transmissions specify additional control signaling via a control channel, such as a physical downlink control channel (PDCCH)). The additional control signaling may increase overhead, increase latency, and/or degrade reliability.

Aspects of the present disclosure improve SPS and/or configured grant transmissions to satisfy survival time specifications for services, such as IIOT and/or URLLC.

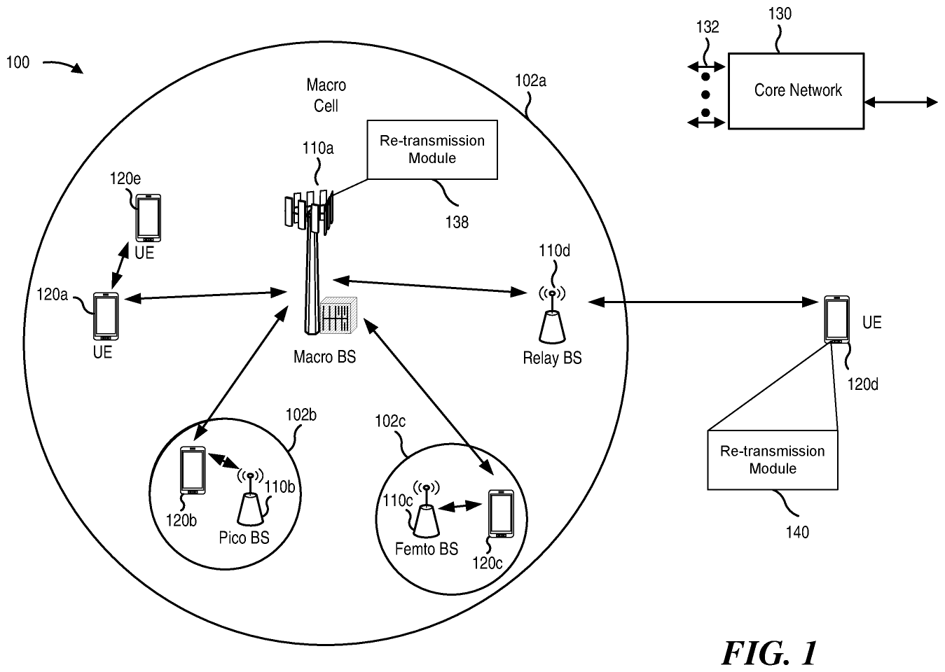

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G node B (NB), an access point, a transmit and receive point (TRP), and/or the like. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a PDU session for a network slice. In some cases, the UE 120 may select a network slice based on an application or subscription service. By having different network slices serving different applications or subscriptions, the UE 120 may improve its resource utilization in the wireless communications system 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a re-transmission module 140. For brevity, only one UE 120d is shown as including the re-transmission module 140. The re-transmission module 140 may transmit a negative acknowledgement (NACK) in response to a transmission from a base station. The re-transmission module 140 may also switch to a supplemental semi-persistent scheduling (SPS) for receiving downlink re-transmissions in response to transmitting the NACK. The re-transmission module 140 may further receive the downlink re-transmissions according to the supplemental SPS.

In some aspects, the re-transmission module 140 may receive downlink feedback information (DFI) for a packet. In this aspects, re-transmission module 140 may also determine a resource block allocation, a start and length indicator value (SLIV), and/or a number of repetitions for re-transmission of the packet in response to the DFI. Furthermore, in this aspect, the re-transmission module 140 may re-transmit the packet during a re-transmission period based on the resource block allocation, the SLIV, and/or the number repetition.

The base stations 110 may include a re-transmission module 138, in some aspects, the re-transmission module 138 may receive a negative acknowledgement (NACK) in response to transmitting a message to a user equipment (UE). In this aspect, the re-transmission module 138 may also switch to a supplemental semi-persistent scheduling (SPS) for re-transmitting the message in response to receiving the NACK. The re-transmission module 138 may further re-transmit the message according to the supplemental SPS.

In some aspects, the re-transmission module 138 may transmit downlink feedback information (DFI) for a packet. In this aspect, the re-transmission module 138 may receive re-transmissions of the packing during a re-transmission period based on an adjusted resource block allocation, an adjusted start and length indicator value (SLIV), and/or a number of repetitions in response to the DFI.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband Internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

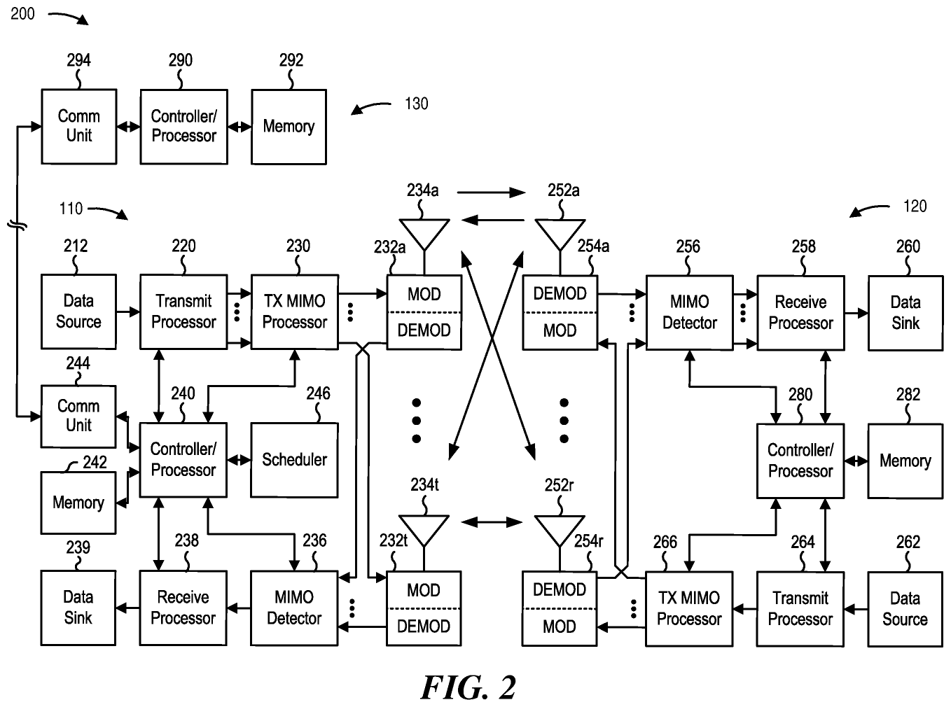

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

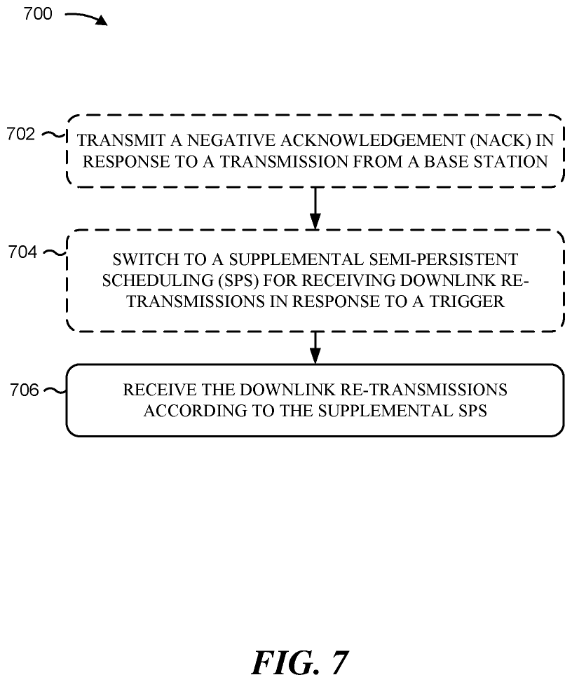

The controller/processor 240 of the base station 110, the controller/processor 280 of the UE 120, and/or any other component(s) of FIG. 2 may perform one or more techniques associated with SPS and configured grant adjustments as described in more detail elsewhere. For example, the controller/processor 240 of the base station 110, the controller/processor 280 of the UE 120, and/or any other component(s) of FIG. 2 may perform or direct operations of, for example, the process of FIGS. 7-10 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for transmitting a negative acknowledgement (NACK) in response to a transmission from a base station; means for switching to a supplemental semi-persistent scheduling (SPS) for receiving downlink re-transmissions in response to transmitting the NACK; and means for receiving the downlink re-transmissions according to the supplemental SPS. In some aspects, the UE 120 may include means for receiving downlink feedback information (DFI) for a packet; means for determining a resource block allocation, a start and length indicator value (SLIV), and/or a number of repetitions for re-transmission of the packet in response to the DFI; and means for re-transmitting the packet during a re-transmission period based on the resource block allocation, the SLIV, and/or the number repetition.

In some aspects, the base station 110 may include means for receiving a negative acknowledgement (NACK) in response to transmitting a message to a user equipment (UE); means for switching to a supplemental semi-persistent scheduling (SPS) for re-transmitting the message in response to receiving the NACK; and means for re-transmitting the message according to the supplemental SPS. In some aspects, the base station 110 may include means for transmitting downlink feedback information (DFI) for a packet; and means for receiving re-transmissions of the packing during a re-transmission period based on an adjusted resource block allocation, an adjusted start and length indicator value (SLIV), and/or a number of repetitions in response to the DFI.

Such means may include one or more components of the UE 120 or base station 110 described in connection with FIG. 2.

As indicated above, FIG. 2 is provided merely as an example. Other examples may differ from what is described with regard to FIG. 2.

In some cases, latency may be reduced and/or reliability may be increased by reducing dynamic control signaling. In some cases, semi-static allocation patterns may reduce the use of dynamic control signaling. Semi-persistent scheduling (SPS) is an example of a semi-static allocation pattern. SPS eliminates, or reduces, downlink control channel (e.g., physical downlink control channel (PDCCH)) overhead where data inter-arrival times are constant. When a UE is configured with SPS, certain parameters, such as a number of hybrid automatic repeat request (HARD) processes and transmission periodicity, may be indicated via radio resource control (RRC) signaling. The UE may be activated to use such parameters (e.g., via PDCCH) for additional SPS transmissions without monitoring/decoding additional downlink control channels. The downlink control channel for activating the SPS transmissions/receptions may be scrambled by a configured scheduling-radio network temporary identifier (CS-RNTI).

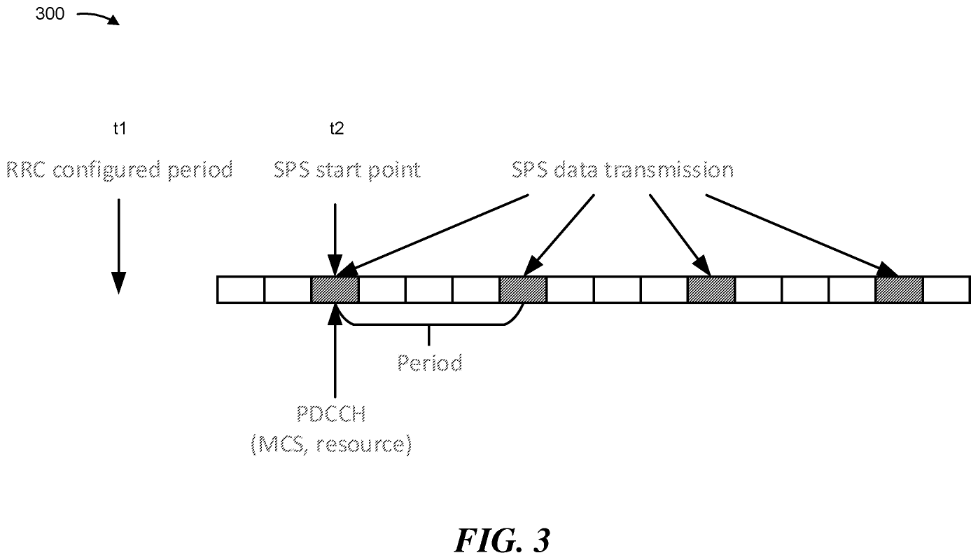

Aspects of the present disclosure are directed to improving downlink SPS transmissions. FIG. 3 is a block diagram illustrating an example of downlink SPS transmissions 300. As described, a base station (e.g., gNB) may periodically allocate resources to a specific UE with pre-configured parameters. The UE may receive downlink messages on the periodically allocated resources. As shown in FIG. 3, at time t1, radio resource control (RRC) signals are received at a slot to configure parameters, such as the periodicity. Additionally, at time t2, a configured scheduling-radio network temporary identifier (CS-RNTI) scrambled physical downlink control channel (PDCCH) is received to inform the UE of resource allocation, modulation and coding scheme (MCS), and other parameters. The PDCCH at time t2 may also activate the SPS. That is, the SPS may start at time t2. The SPS reduces, or eliminates, downlink control information (DCI) transmissions per transmission time interval (TTI). As such, downlink control channel (e.g., PDCCH) overhead is reduced.

As shown in FIG. 3, SPS transmissions are received at a configured periodicity (e.g., a period between slots for the SPS transmission) after the SPS starting point of time t2. In conventional systems, SPS transmissions are specified for new transmissions. That is, SPS transmissions are not scheduled for re-transmissions in response to a failed downlink transmission.

In addition to, or alternate from, SPS transmissions, some systems use configured grant transmissions to reduce latency and/or improve reliability. Configured grant transmissions may refer to transmissions, such as data message transmissions, without resources dedicated/allocated in an uplink grant. The configured grant transmissions may be referred to as grant-free transmissions. Two types of configured grant uplink (UL) transmissions may be specified: Type 1 and Type 2.

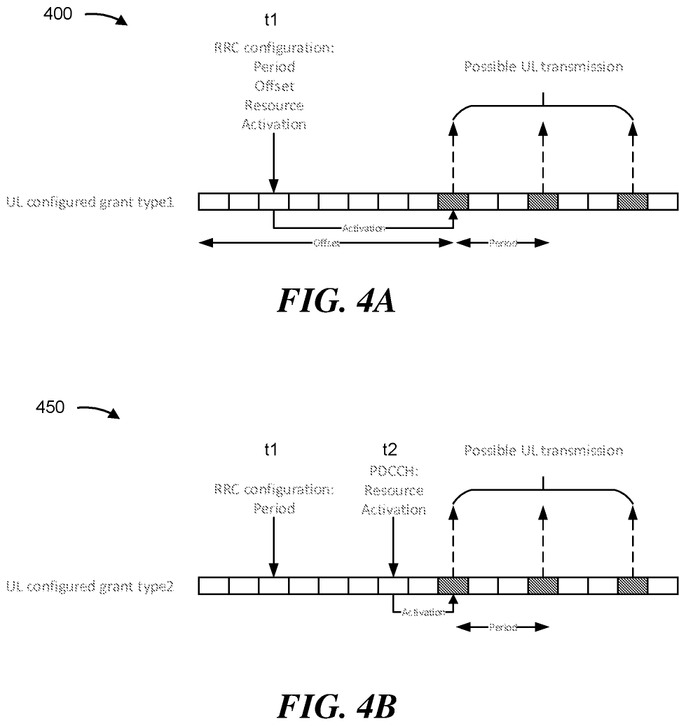

FIG. 4A is a block diagram illustrating an example 400 of a Type 1 configured grant UL data transmission. For Type 1, the configured grant UL transmission may be based on an RRC configuration received at time t1. The RRC configuration may be received without layer 1 (L1) signaling. The RRC configuration may provide parameters for the UL transmission, such as an offset, time/frequency resources, a periodicity of the UL transmissions, and/or an activation. As shown in FIG. 4A, potential UL transmissions may be scheduled at a specified periodicity (e.g., a period between slots specified for the UL transmissions). The initial UL transmission may occur at a number of slots after receiving the activation in the RRC configuration.

FIG. 4B is a block diagram illustrating an example 450 of a Type 2 configured grant UL transmission. For Type 2, the configured grant UL transmissions may be configured via RRC signaling and activated/deactivated via downlink control information (DCI) (e.g., L1 signaling). As shown in FIG. 4B, at time t1, the UE receives an RRC configuration providing a periodicity for the UL transmissions. At time t2, the UE receives control information, such as a DCI message, providing time/frequency resources for the transmissions and an activation. As shown in FIG. 4B, potential UL transmissions may be scheduled at a specified periodicity (e.g., a period between slots specified for the UL transmissions). The initial UL transmission may occur a number of slots after receiving the activation in the control information at time t2.

In some cases, configured grant transmissions and/or SPS transmissions may use transport block (TB) repetitions (with a same or different redundancy version (RV) index) to increase reliability. For example, a number of repetitions (e.g., up to 8 re-transmissions) may be specific for an initial configured grant transmission. An RV index may be specified for each repetition. Using UL configured grant transmissions as an example, each HARQ identifier (ID) may have up to K repetitions, where K∈{1, 2, 4, 8}.

Although configured grant transmissions may be associated with a predefined number of (K) repetitions, such a design may have some drawbacks. For example, there may be cases (e.g., when channel conditions are above a threshold) in which a given UE may not perform all K number of repetitions. In one example, if a transport block is successfully decoded at one or more first repetitions, remaining repetitions aggregated with K may cause unnecessary interference to other UEs that share the same resource(s), which in turn may degrade network reliability.

In some cases, a transmitter may stop repetitions if an acknowledgment (ACK) is received. Such ACK signaling may also have some drawbacks. For example, ACK signaling may increase overhead. In addition, the ACK signaling may increase latency in a time domain for slot format related information (SFI). Therefore, it is desirable to improve configured grant transmissions to provide re-transmissions without reliance on dynamic grants.

As described, in Release 17 and beyond, survival time may be specified for enhanced industrial internet of things (IIoT) and ultra-reliable low-latency communication (URLLC). For downlink (DL) transmissions, survival time may be implemented by a base station (e.g., gNB). For example, if the base station identifies a failed downlink packet based on UE feedback (e.g., a negative acknowledgment (NACK), the base station may increase a resource block (RB) allocation or a start and length indicator value (SLIV) for one or more subsequent packets.

For uplink (UL) transmissions, the base station may issue an UL grant with enhanced power control and improved RB, SLIV, and/or repetition allocation if the base station failed to decode an uplink channel, such as a physical uplink shared channel (PUSCH). To reduce control signal overhead for services such as IIoT and URLLC (e.g., small packet transmissions), aspects of the present disclosure improve re-transmissions without relying on a dynamic grant (DG) for semi-persistent scheduling (SPS)/cell group (CG) enhancements.

In some aspects, additional resources are configured for re-transmissions, and a nominal coding rate of a new assignment is less than an initial transmission to improve performance and satisfy latency specifications. For SPS DL transmissions, a supplemental SPS is defined for re-transmissions. The supplemental SPS may configure resource blocks and/or SLIV for the re-transmissions. The resource block and SLIV configurations for the supplemental SPS may be different from the resource block, and SLIV configurations for an initial SPS, such as the SPS configured with respect to FIG. 3. For configured grant UL transmission, a new resource block, SLIV, and/or repetition allocation may be configured for re-transmissions.

In one configuration, a supplemental SPS is defined for DL re-transmissions. In this configuration, when a UE sends a negative acknowledgment (NACK), the UE automatically uses a different resource block and/or SLIV assignment for subsequent DL transmissions (e.g., DL packets). The supplemental SPS may be an offset of an initial SPS transmission. The resource block and/or SLIV allocation, as well as a re-transmission switch period, may be pre-configured for the supplemental SPS.

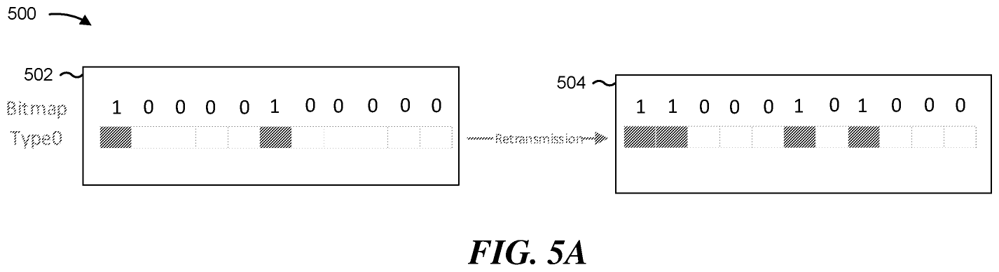

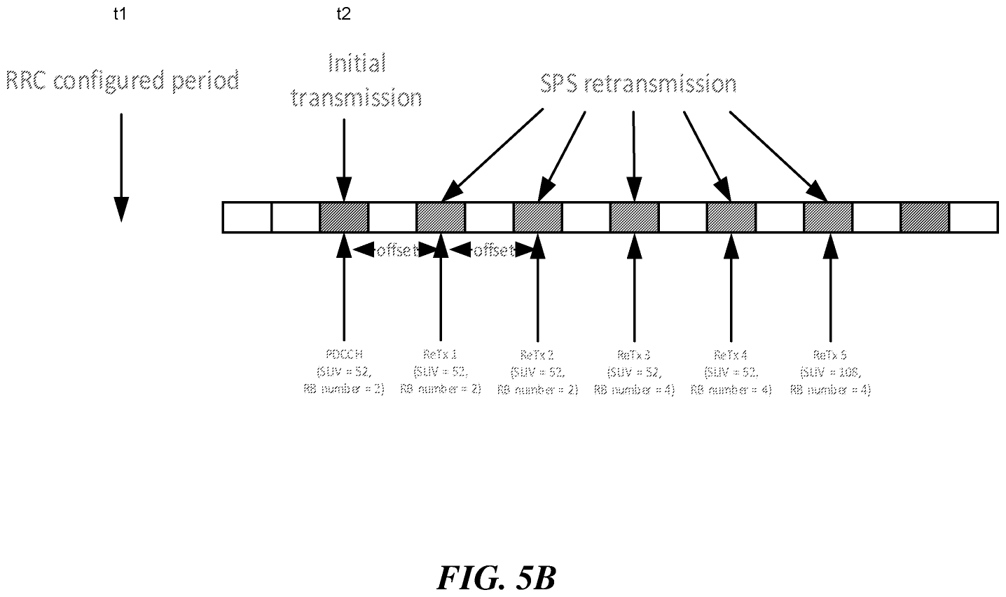

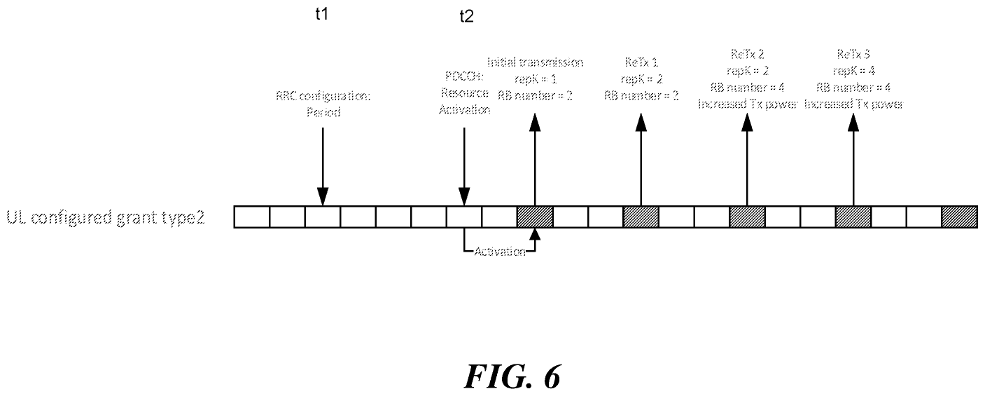

FIG. 5A is a block diagram illustrating an example of a resource block (RB) allocation 500, in accordance with aspects of the present disclosure. In the example of FIG. 5A, a first RB allocation 502 for an initial SPS may be allocated based on a bitmap (e.g., shown as Bitmap Type0). A value of one represents an allocated RB and a value of zero represents an unallocated RB. For the supplemental SPS, a second RB allocation 504 may increase a number of allocated RBs.

Additionally, or alternatively, in one configuration, the supplemental SPS allocates additional symbols to improve performance. TABLE 1 provides an example of symbol allocation according to aspects of the present disclosure. In TABLE 1, L is a length of symbols (e.g., number of symbols) and S is a starting symbol. In one example, an initial SPS configuration may allocate four symbols with a SLIV of 51 or 52. In this example, the supplemental SPS may increase a number of symbols to eight, nine, ten, eleven, or twelve, for example.

TABLE 1

| Row | dmrs-TypeA- | PDSCH | | | | |
|---|---|---|---|---|---|---|
| index | Position | mapping type | K [symbol] | S | L | SLIV |
| 1 | 2 | Type A | 0 | 2 | 12 | 53 |
| | 3 | Type A | 0 | 3 | 11 | 66 |
| 2 | 2 | Type A | 0 | 2 | 10 | 81 |
| | 3 | Type A | 0 | 3 | 9 | 94 |
| 3 | 2 | Type A | 0 | 2 | 9 | 95 |
| | 3 | Type A | 0 | 3 | 8 | 108 |
| . | | | | | | |
| . | | | | | | |
| . | | | | | | |
| 6 | 2 | Type B | 0 | 9 | 4 | 51 |
| | 3 | Type B | 0 | 10 | 4 | 52 |

[symbol]

indicates data missing or illegible when filed

Additionally, or alternatively, the supplemental SPS configures a number of allowed re-transmissions before the UE can switch parameters. FIG. 5B is a block diagram illustrating an example of switching parameters during re-transmissions, in accordance with aspects of the present disclosure. As shown in FIG. 5B, at time t1, the UE receives an RRC configuration for configuring the supplemental SPS. The RRC configuration may also configure the initial SPS and may indicate initial parameters, such as the SLIV and a number of resource blocks allocated per slot. At time t2, the UE may receive a downlink control channel (e.g., downlink control information (DCI)) to activate the supplemental SPS. The downlink control channel received at time t2 may also activate the initial SPS. In the example of FIG. 5B, for the initial SPS (shown as initial transmission in FIG. 5B), an initial SLIV is 52 and an initial resource block allocation is two.

In one configuration, the RRC configuration specifies an offset between re-transmissions, a number of re-transmissions, and a switch period for the supplemental SPS. The offset specifies an offset from each SPS transmission/re-transmission. In the example of FIG. 5B, the offset is two. That is, an initial SPS re-transmission may occur two slots after the initial SPS transmission. Furthermore, each SPS re-transmission may occur two slots after a previous SPS re-transmission.

The number of re-transmissions specifies the number of SPS re-transmissions that may occur during a re-transmission period. In the example of FIG. 5B, the number of re-transmissions is five, such that only five SPS re-transmissions occur (shown as ReTx1 to ReTx5 in FIG. 5B). The switch period specifies a number of slots before the base station may switch one or more parameters of the SPS re-transmission. In the example of FIG. 5B, the switch period is four slots, such that the parameters may be switched after every four slots. In this example, ReTx1 and ReTx2 have the same parameters (e.g., SLIV and RB number). ReTx3 is scheduled four slots after ReTx1, therefore, the parameters for ReTx3 may be switched. As shown in FIG. 5B, the number of RBs allocated to ReTx3 are increased to four. Additionally, a number of slots between ReTx3 and ReTx4 is less than four slots, therefore, ReTx3 and ReTx4 have the same parameters. In the example of FIG. 5B, the parameters for ReTx5 are switched to increase the SLIV to 108.

In another aspect of the present disclosure, the configured grant UL re-transmission is improved. In this aspect, when a UE receives a downlink feedback indication (DFI) for a transmission, the UE may adjust a number of repetitions, use a different resource block allocation, and/or a different SLIV for subsequent transmissions (e.g., re-transmissions). The downlink feedback indication may indicate a failure to decode the transmission.

In one configuration, the UE increases a number of resource blocks for each re-transmission. The number of resource blocks may be increased from a number of resource blocks allocated for an initial transmission. Additionally, or alternatively, the UE may increase a number of symbols allocated for each re-transmission. The number of symbols may be increased from a number of symbols allocated for an initial transmission. Additionally, or alternatively, the UE may increase a number of repetitions allocated for each re-transmission. The number of repetitions may be increased from a number of repetitions allocated for an initial transmission. Additionally, or alternatively, a switch period may be configured for switching parameters during a number of allowed re-transmissions.

The parameters described above for the UL re-transmissions may be for Type 1 or Type 2 configured grant UL transmissions. For Type 1, the parameters may be configured via RRC signaling. For Type 2, the parameters may be configured via control signaling, such as downlink control information (DCI), received via a downlink control channel.

FIG. 6 is a block diagram illustrating an example of a Type 2 configured grant transmission and re-transmissions, in accordance with aspects of the present disclosure. As shown in FIG. 6, at time t1, the UE receives an RRC configuration for the initial UL transmission and the UL re-transmissions. The RRC configuration may include parameters for a number (K) of repetitions (repK), a number of allocated resource blocks, a number of symbols, switch period, a number of re-transmissions, and/or a periodicity for the UL re-transmissions. At time t2, the UE receives control information, such as a DCI message, providing time/frequency resources for the transmission and re-transmissions as well as an activation.

As shown in FIG. 6, a number of resource blocks (shown as RB number) for an initial transmission is two, and a number of repetitions is one. In the example of FIG. 6, three re-transmissions are configured (shown as ReTx1, ReTx2, and ReTx3). In this example, ReTx1 is configured to increase a number of repetitions (repK) in comparison to the initial transmission. That is, the number of repetitions is increased from one to two.

Additionally, in the example of FIG. 6, the switch period is three slots, such that parameters of the re-transmissions may be switched every three slots. As such, the parameters of ReTx2 may be switched. As shown in FIG. 6, a number of resource blocks configured for ReTx2 is increased from four to two. Furthermore, for ReTx3, a number of repetitions is increased from two to four.

Aspects of the present disclosure are not limited to re-transmissions for Type 2 configured grant transmissions, re-transmissions may also be configured for Type 1 configured grant transmissions.

As indicated above, FIGS. 3-6 are provided as examples. Other examples may differ from what is described with respect to FIGS. 3-6.

FIG. 7 is a diagram illustrating an example process 700 performed, for example, by a user equipment (UE), in accordance with various aspects of the present disclosure. The example process 700 is an example of adjusting semi-persistent scheduling (SPS) transmission parameters. As shown in FIG. 7, in some aspects, the process 700 may include transmitting a negative acknowledgement (NACK) in response to a transmission from a base station (block 702). For example, the UE (e.g., using the antenna 252, DEMOD/MOD 254, TX MIMO processor 266, transmit processor 264, controller/processor 280, and/or memory 282) can transmit a NACK in response to a transmission from a base station.

As shown in FIG. 7, in some aspects, the process 700 may include switching to a supplemental semi-persistent scheduling (SPS) for receiving downlink re-transmissions in response to a trigger (block 704). As an example, the trigger may include transmitting the NACK. For example, the UE (e.g., using the antenna 252, DEMOD/MOD 254, MIMO detector 255, receive processor 258, controller/processor 280, and/or memory 282) can switch to a supplemental SPS for receiving downlink re-transmissions in response to a trigger. In some aspects, the process 700 may include receiving the downlink re-transmissions according to the supplemental SPS (block 706). For example, the UE (e.g., using the antenna 252, DEMOD/MOD 254, MIMO detector 255, receive processor 258, controller/processor 280, and/or memory 282) can receive the downlink re-transmissions according to the supplemental SPS.

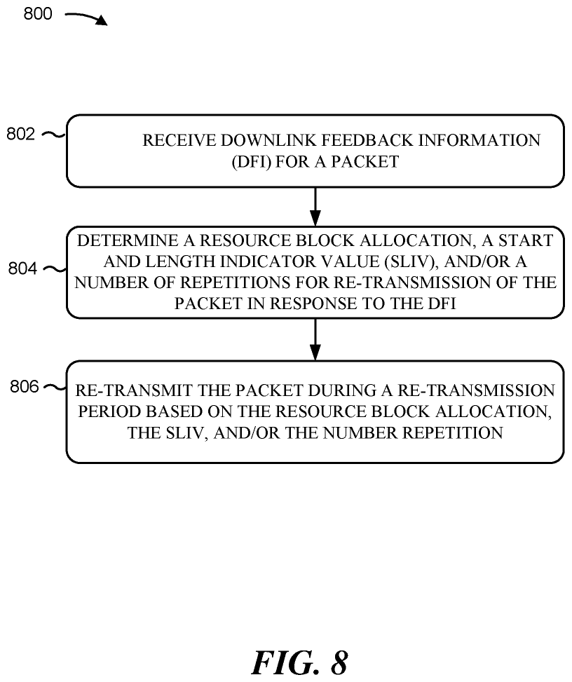

FIG. 8 is a diagram illustrating an example process 800 performed, for example, by a UE, in accordance with various aspects of the present disclosure. The example process 800 is an example of for adjusting configured grant (CG) transmission parameters. As shown in FIG. 8, in some aspects, the process 800 may include receiving downlink feedback information (DFI) for a packet (block 802). For example, the UE (e.g., using the antenna 252, DEMOD/MOD 254, MIMO detector 255, receive processor 258, controller/processor 280, and/or memory 282) can receiving DFI for a packet.

As shown in FIG. 8, in some aspects, the process 800 may include determining a resource block allocation, a start and length indicator value (SLIV), and/or a number of repetitions for re-transmission of the packet in response to the DFI (block 804). For example, the UE (e.g., using the antenna 252, DEMOD/MOD 254, TX MIMO processor 266, transmit processor 264, controller/processor 280, and/or memory 282) can determine a resource block allocation, a SLIV, and/or a number of repetitions for re-transmission of the packet in response to the DFI. In some aspects, the process 800 may re-transmitting the packet during a re-transmission period based on the resource block allocation, the SLIV, and/or the number repetition (block 806). For example, the UE (e.g., using the antenna 252, DEMOD/MOD 254, TX MIMO processor 266, transmit processor 264, controller/processor 280, and/or memory 282) can re-transmit the packet during a re-transmission period based on the resource block allocation, the SLIV, and/or the number repetition.

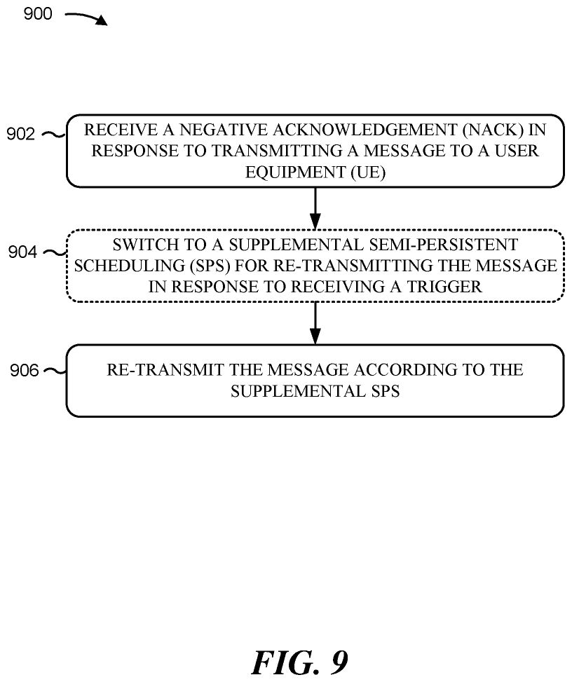

FIG. 9 is a diagram illustrating an example process 900 performed, for example, by a base station, in accordance with various aspects of the present disclosure. The example process 900 is an example of adjusting semi-persistent scheduling (SPS) transmission parameters. The process 900 may include transmitting a supplemental SPS to the UE via a RRC configuration (not shown in FIG. 9). The process 900 may also include transmitting a message to the UE (not shown in FIG. 9). As shown in FIG. 9, in some optional aspects, the process 900 includes receiving a negative acknowledgement (NACK) in response to transmitting a message to a user equipment (UE) (block 902). For example, the base station (e.g., using the antenna 234, receive processor 238, controller/processor 240, and/or memory 242) can receive a NACK in response to transmitting a message to a UE. As shown in FIG. 9, in some aspects, the process 900 may include switching to a supplemental semi-persistent scheduling (SPS) for re-transmitting the message in response to a trigger (block 904). In one implementation, the trigger includes receiving the NACK. For example, the base station (e.g., using the antenna 234, MOD/DEMOD 232, TX MIMO processor 230, transmit processor 220, controller/processor 240, and/or memory 242) can switch to a supplemental SPS for re-transmitting the message in response to receiving the trigger.

As shown in FIG. 9, in some aspects, the process 900 may include re-transmitting the message according to the supplemental SPS (block 906). For example, the base station (e.g., using the antenna 234, MOD/DEMOD 232, TX MIMO processor 230, transmit processor 220, controller/processor 240, and/or memory 242) can re-transmit the message according to the supplemental SPS.

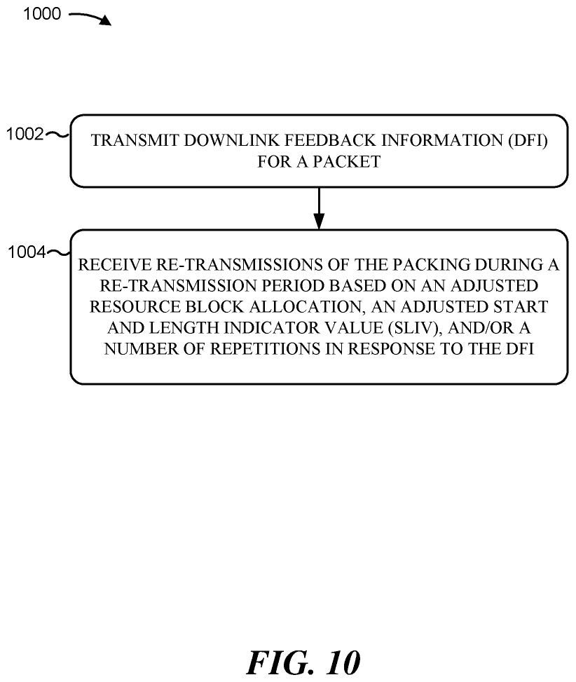

FIG. 10 is a diagram illustrating an example process 1000 performed, for example, by a base station, in accordance with various aspects of the present disclosure. The example process 1000 is an example of adjusting configured grant (CG) transmission parameters. As shown in FIG. 10, in some aspects, the process 1000 may include transmitting downlink feedback information (DFI) for a packet (block 1002). For example, the base station (e.g., using the antenna 234, MOD/DEMOD 232, TX MIMO processor 230, transmit processor 220, controller/processor 240, and/or memory 242) can transmitting DFI for a packet. In some aspects, the process 1000 may include receiving re-transmissions of the packing during a re-transmission period based on an adjusted resource block allocation, an adjusted start and length indicator value (SLIV), and/or a number of repetitions in response to the DFI (block 1004). For example, the base station (e.g., using the antenna 234, receive processor 238, controller/processor 240, and/or memory 242) can receiving re-transmissions of the packing during a re-transmission period based on an adjusted resource block allocation, an adjusted SLIV, and/or a number of repetitions in response to the DFI.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving supplemental semi-persistent scheduling (SPS) via radio resource control (RRC) signaling; and
receiving downlink re-transmissions according to the supplemental SPS.

2. The method of claim 1, further comprising switching to the supplemental SPS in response to a trigger.

3. The method of any of claims 1 to 2, further comprising transmitting a negative acknowledgement (NACK) in response to a transmission from a base station, in which the trigger comprises transmitting the NACK.

4. The method of any of claims 1 to 3, in which the supplemental SPS comprises one or more of a resource block allocation, a start and length indicator value (SLIV), or a re-transmission switch period.

5. The method of any of claims 1 to 4, in which the resource block allocation and the SLIV of the supplemental SPS are different from a resource block allocation and a SLIV of the initial SPS.

6. The method of any of claims 1 to 5, in which a number of resource blocks of the supplemental SPS is greater than a number of resource blocks of the initial SPS.

7. The method of any of claims 1 to 6, in which a number of symbols of the supplemental SPS is greater than a number of symbols of the initial SPS.

8. The method of any of claims 1 to 7, in which the supplemental SPS configures one or more of a number of re-transmissions and an offset for switching a number of resource blocks or a start and length indicator value (SLIV) during the number of re-transmissions.

9. The method of any of claims 1 to 8, further comprising:
receiving downlink control information;
activating the supplemental SPS via the downlink control information.

10. A user equipment (UE) for wireless communication, comprising:
means for receiving supplemental semi-persistent scheduling (SPS) via radio resource control (RRC) signaling; and
means for receiving downlink re-transmissions according to the supplemental SPS.

11. The UE of claim 10, further comprising means for switching to the supplemental SPS in response to a trigger.

12. The UE of claim 11, further comprising means for transmitting a negative acknowledgement (NACK) in response to a transmission from a base station, in which the trigger comprises transmitting the NACK.

13. The UE of claim 10, in which the supplemental SPS comprises one or more of a resource block allocation, a start and length indicator value (SLIV), or a re-transmission switch period.

14. The UE of claim 13, in which the resource block allocation and the SLIV of the supplemental SPS are different from a resource block allocation and a SLIV of the initial SPS.

15. The UE of claim 13, in which a number of resource blocks of the supplemental SPS is greater than a number of resource blocks of the initial SPS.

16. The UE of claim 13, in which a number of symbols of the supplemental SPS is greater than a number of symbols of the initial SPS.

17. The UE of claim 10, in which the supplemental SPS configures one or more of a number of re-transmissions and an offset for switching a number of resource blocks or a start and length indicator value (SLIV) during the number of re-transmissions.

18. The UE of claim 10, further comprising:
means for receiving downlink control information; and
means for activating the supplemental SPS via the downlink control information.

19. An apparatus for wireless communications at a user equipment (UE), comprising:
a processor;
a memory coupled with the processor; and
instructions stored in the memory and operable, when executed by the processor, to cause the apparatus:
to receive supplemental semi-persistent scheduling (SPS) via radio resource control (RRC) signaling; and
to receive downlink re-transmissions according to the supplemental SPS.

20. The apparatus of claim 19, in which the instructions further cause the apparatus to switch to the supplemental SPS in response to a trigger.

21. The apparatus of claim 20, in which the instructions further cause the apparatus to transmit a negative acknowledgement (NACK) in response to a transmission from a base station, in which the trigger comprises transmitting the NACK.

22. The apparatus of claim 19, in which the supplemental SPS comprises one or more of a resource block allocation, a start and length indicator value (SLIV), or a re-transmission switch period.

23. The apparatus of claim 22, in which the resource block allocation and the SLIV of the supplemental SPS are different from a resource block allocation and a SLIV of the initial SPS.

24. The apparatus of claim 22, in which a number of resource blocks of the supplemental SPS is greater than a number of resource blocks of the initial SPS.

25. The apparatus of claim 22, in which a number of symbols of the supplemental SPS is greater than a number of symbols of the initial SPS.

26. The apparatus of claim 19, in which the supplemental SPS configures one or more of a number of re-transmissions and an offset for switching a number of resource blocks or a start and length indicator value (SLIV) during the number of re-transmissions.

27. The apparatus of claim 19, in which the instructions further cause the apparatus:
to receive downlink control information; and
to activate the supplemental SPS via the downlink control information.

28. A non-transitory computer-readable medium having program code recorded thereon for wireless communication, the program code executed by a processor and comprising:
program code to receive supplemental semi-persistent scheduling (SPS) via radio resource control (RRC) signaling; and
program code to receive downlink re-transmissions according to the supplemental SPS.

29. A method of wireless communication performed by a user equipment (UE), comprising:
receiving downlink feedback information (DFI) for a packet;
determining one or more of resource block allocation, a start and length indicator value (SLIV), or a number of repetitions for re-transmission of the packet in response to the DFI; and
re-transmitting the packet during a re-transmission period based on one or more of the resource block allocation, the SLIV, or the number repetition.

30. The method of claim 29, further comprising increasing a number of resource blocks allocated for the re-transmission.

31. The method any of claims 29 to 30, further comprising increasing a number of symbols allocated for the re-transmission.

32. The method any of claims 29 to 31, further comprising increasing the number of repetitions allocated for the re-transmission.

33. The method any of claims 29 to 32, further comprising configuring one or more of a switch period for adjusting the resource block allocation or the number of repetitions during the re-transmission period.

34. The method of any of claims 29 to 33, further comprising:
receiving one or more of a configuration for the resource block allocation, the SLIV, or the number of repetitions via radio resource control (RRC) signaling; and
activating the configuration based on downlink control information (DCI).

35. The method of any of claims 29 to 34, further comprising:
receiving one or more of a configuration for the resource block allocation, the SLIV, or the number of repetitions via downlink control information (DCI); and
activating the configuration based on the DCI.

36. A user equipment (UE) for wireless communication, comprising:
means for receiving downlink feedback information (DFI) for a packet;
means for determining one or more of a resource block allocation, a start and length indicator value (SLIV), or a number of repetitions for re-transmission of the packet in response to the DFI; and
means for re-transmitting the packet during one or more of a re-transmission period based on the resource block allocation, the SLIV, or the number repetition.

37. The UE of claim 36, further comprising means for increasing a number of resource blocks allocated for the re-transmission.

38. The UE of claim 36, further comprising means for increasing a number of symbols allocated for the re-transmission.

39. The UE of claim 36, further comprising means for increasing the number of repetitions allocated for the re-transmission.

40. The UE of claim 36, further comprising means for configuring one or more of a switch period for adjusting the resource block allocation or the number of repetitions during the re-transmission period.

41. The UE of claim 36, further comprising:
means for receiving one or more of a configuration for the resource block allocation, the SLIV, or the number of repetitions via radio resource control (RRC) signaling; and
means for activating the configuration based on downlink control information (DCI).

42. The UE of claim 36, further comprising:
means for receiving one or more of a configuration for the resource block allocation, the SLIV, or the number of repetitions via downlink control information (DCI); and
means for activating the configuration based on the DCI.

43. An apparatus for wireless communications at a user equipment (UE), comprising:
a processor;
a memory coupled with the processor; and
instructions stored in the memory and operable, when executed by the processor, to cause the apparatus:
to receive downlink feedback information (DFI) for a packet;
to determine one or more of a resource block allocation, a start and length indicator value (SLIV), or a number of repetitions for re-transmission of the packet in response to the DFI; and
to re-transmit the packet during a re-transmission period based on one or more of the resource block allocation, the SLIV, or the number repetition.

44. The apparatus of claim 43, in which the instructions further cause the apparatus to increase a number of resource blocks allocated for the re-transmission.

45. The apparatus of claim 43, in which the instructions further cause the apparatus to increase a number of symbols allocated for the re-transmission.

46. The apparatus of claim 43, in which the instructions further cause the apparatus to increase the number of repetitions allocated for the re-transmission.

47. The apparatus of claim 43, in which the instructions further cause the apparatus to configure one or more of a switch period for adjusting the resource block allocation or the number of repetitions during the re-transmission period.

48. The apparatus of claim 43, in which the instructions further cause the apparatus:
to receive one or more of a configuration for the resource block allocation, the SLIV, or the number of repetitions via radio resource control (RRC) signaling; and
to activate the configuration based on downlink control information (DCI).

49. The apparatus of claim 43, in which the instructions further cause the apparatus:
to receive one or more of a configuration for the resource block allocation, the SLIV, or the number of repetitions via downlink control information (DCI); and
to activate the configuration based on the DCI.

50. A non-transitory computer-readable medium having program code recorded thereon for wireless communication, the program code executed by a processor and comprising:
program code to receive downlink feedback information (DFI) for a packet;
program code to determine one or more of a resource block allocation, a start and length indicator value (SLIV), or a number of repetitions for re-transmission of the packet in response to the DFI; and
program code to re-transmit the packet during a re-transmission period based on one or more of the resource block allocation, the SLIV, or the number repetition.

51. A method of wireless communication performed by a base station, comprising:
transmitting, to a user equipment (UE), supplemental SPS via radio resource control (RRC) signaling;
transmitting a message to the UE; and
re-transmitting, to the UE, a message according to the supplemental SPS.

52. The method of claim 51, further comprising switching to a supplemental semi-persistent scheduling (SPS) for re-transmitting the message in response to a trigger.

53. The method of any of claims 50 to 52, further comprising receiving a negative acknowledgement (NACK) in response to transmitting the message, in which the trigger comprises receiving the NACK.

54. The method of any of claims 50 to 53, in which the supplemental SPS comprises one or more of a resource block allocation, a start and length indicator value (SLIV), or a re-transmission switch period.

55. The method of any of claims 50 to 54, in which the resource block allocation and the SLIV of the supplemental SPS are different from a resource block allocation and an SLIV of the initial SPS.

56. The method of any of claims 50 to 55, in which a number of resource blocks of the supplemental SPS is greater than a number of resource blocks of the initial SPS.

57. The method of any of claims 50 to 56, in which a number of symbols of the supplemental SPS is greater than a number of symbols of the initial SPS.

58. The method of any of claims 50 to 57, in which the supplemental SPS configures one or more of a number of re-transmissions and an offset for switching a number of resource blocks or a start and length indicator value (SLIV) during the number of re-transmissions.

59. The method of any of claims 50 to 58, further comprising transmitting downlink control information for activating the supplemental SPS.

60. A base station for wireless communication, comprising:
means for transmitting, to a user equipment (UE), supplemental SPS via radio resource control (RRC) signaling;
means for transmitting a message to the UE; and
means for re-transmitting, to the UE, a message according to the supplemental SPS.

61. The base station of claim 60, further comprising means for switching to a supplemental semi-persistent scheduling (SPS) for re-transmitting the message in response to a trigger.

62. The base station of claim 61, further comprising means for receiving a negative acknowledgement (NACK) in response to transmitting the message, in which the trigger comprises receiving the NACK.

63. The base station of claim 60, in which:
the supplemental SPS is an offset of an initial SPS; and
the supplemental SPS comprises a resource block allocation, a start and length indicator value (SLIV), and a re-transmission switch period.

64. The base station of claim 63, in which the resource block allocation and the SLIV of the supplemental SPS are different from a resource block allocation and an SLIV of the initial SPS.

65. The base station of claim 63, in which a number of resource blocks of the supplemental SPS is greater than a number of resource blocks of the initial SPS.

66. The base station of claim 63, in which a number of symbols of the supplemental SPS is greater than a number of symbols of the initial SPS.

67. The base station of claim 60, in which the supplemental SPS configures one or more of a number of re-transmissions and an offset for switching a number of resource blocks or a start and length indicator value (SLIV) during the number of re-transmissions.

68. The base station of claim 63, further comprising means for transmitting downlink control information for activating the supplemental SPS.

69. An apparatus for wireless communications at a base station, comprising:
a processor;
a memory coupled with the processor; and
instructions stored in the memory and operable, when executed by the processor, to cause the apparatus:
to transmit, to a user equipment (UE), supplemental SPS via radio resource control (RRC) signaling;
to transmit a message to the UE; and
to re-transmit, to the UE, a message according to the supplemental SPS.

70. The apparatus of claim 69, in which the instructions further cause the apparatus to switch to a supplemental semi-persistent scheduling (SPS) for re-transmitting the message in response to a trigger.

71. The base station of claim 70, in which the instructions further cause the apparatus to receive a negative acknowledgement (NACK) in response to transmitting the message, in which the trigger comprises receiving the NACK.

72. The apparatus of claim 69, in which the supplemental SPS comprises one or more of a resource block allocation, a start and length indicator value (SLIV), or a re-transmission switch period.

73. The apparatus of claim 72, in which the resource block allocation and the SLIV of the supplemental SPS are different from a resource block allocation and an SLIV of the initial SPS.

74. The apparatus of claim 72, in which a number of resource blocks of the supplemental SPS is greater than a number of resource blocks of the initial SPS.

75. The apparatus of claim 72, in which a number of symbols of the supplemental SPS is greater than a number of symbols of the initial SPS.

76. The apparatus of claim 69, in which the supplemental SPS configures one or more of a number of re-transmissions and an offset for switching a number of resource blocks or a start and length indicator value (SLIV) during the number of re-transmissions.

77. The apparatus of claim 72, in which the instructions further cause the apparatus to transmit downlink control information to activate the supplemental SPS.

78. A non-transitory computer-readable medium having program code recorded thereon for wireless communication, the program code executed by a processor and comprising:
program code to transmit, to a user equipment (UE), supplemental SPS via radio resource control (RRC) signaling;
program code to transmit a message to the UE; and
program code to re-transmit, to the UE, a message according to the supplemental SPS.

79. A method of wireless communication performed by a base station, comprising:
transmitting downlink feedback information (DFI) for a packet; and
receiving re-transmissions of the packing during a re-transmission period based on one or more of an adjusted resource block allocation, an adjusted start and length indicator value (SLIV), or a number of repetitions in response to the DFI.

80. The method of claim 79, further comprising increasing a number of resource blocks allocated for receiving the re-transmissions.

81. The method of any of claims 79 to 80, further comprising increasing a number of symbols allocated for receiving the re-transmissions.

82. The method of any of claims 79 to 81, further comprising increasing the number of repetitions allocated for receiving the re-transmissions.

83. The method of any of claims 79 to 82, further comprising:
transmitting a configuration for one or more of the resource block allocation, the SLIV, or the number of repetitions via radio resource control (RRC) signaling; and
activating the configuration based on downlink control information (DCI).

84. The method of any of claims 79 to 83, further comprising:
transmitting a configuration for one or more of the resource block allocation, the SLIV, or the number of repetitions via downlink control information (DCI); and
activating the configuration based on the DCI.

85. A base station for wireless communication, comprising:
means for transmitting downlink feedback information (DFI) for a packet; and
means for receiving re-transmissions of the packing during a re-transmission period based on one or more of an adjusted resource block allocation, an adjusted start and length indicator value (SLIV), or a number of repetitions in response to the DFI.

86. The base station of claim 85, further comprising means for increasing a number of resource blocks allocated for receiving the re-transmissions.

87. The base station of claim 85, further comprising means for increasing a number of symbols allocated for receiving the re-transmissions.

88. The base station of claim 85, further comprising means for increasing the number of repetitions allocated for receiving the re-transmissions.

89. The base station of claim 85, further comprising:
means for transmitting one or more of a configuration for the resource block allocation, the SLIV, or the number of repetitions via radio resource control (RRC) signaling; and
means for activating the configuration based on downlink control information (DCI).

90. The base station of claim 85, further comprising:
means for transmitting one or more of a configuration for the resource block allocation, the SLIV, or the number of repetitions via downlink control information (DCI); and
means for activating the configuration based on the DCI.

91. An apparatus for wireless communications at a user equipment (UE), comprising:
a processor;
a memory coupled with the processor; and
instructions stored in the memory and operable, when executed by the processor, to cause the apparatus:
to transmit downlink feedback information (DFI) for a packet; and
to receive re-transmissions of the packing during a re-transmission period based on one or more of an adjusted resource block allocation, an adjusted start and length indicator value (SLIV), or a number of repetitions in response to the DFI.

92. The apparatus of claim 91, in which the instructions further cause the apparatus to increase a number of resource blocks allocated for receiving the re-transmissions.

93. The apparatus of claim 91, in which the instructions further cause the apparatus to increase a number of symbols allocated for receiving the re-transmissions.

94. The apparatus of claim 91, in which the instructions further cause the apparatus to increase the number of repetitions allocated for receiving the re-transmissions.

95. The apparatus of claim 91, in which the instructions further cause the apparatus:
to transmit one or more of a configuration for the resource block allocation, the SLIV, or the number of repetitions via radio resource control (RRC) signaling; and
to activate the configuration based on downlink control information (DCI).

96. The apparatus of claim 91, in which the instructions further cause the apparatus:
to transmit a configuration for one or more of the resource block allocation, the SLIV, or the number of repetitions via downlink control information (DCI); and
to activate the configuration based on the DCI.

97. A non-transitory computer-readable medium having program code recorded thereon for wireless communication, the program code executed by a processor and comprising:
program code to transmit downlink feedback information (DFI) for a packet; and
program code to receive re-transmissions of the packing during a re-transmission period based on one or more of an adjusted resource block allocation, an adjusted start and length indicator value (SLIV), or a number of repetitions in response to the DFI.
